(19) United States
(12) Patent Application Publication
(10) Pub. No.: US 2022/0410022 A1
(43) Pub. Date: Dec. 29, 2022

(54) ASSEMBLABLE THREE-DIMENSIONAL STORY AND PICTURE DISPLAY

(71) Applicant: Chris Bayon, Langhorne, PA (US)

(72) Inventor: Chris Bayon, Langhorne, PA (US)

(21) Appl. No.: 17/358,919

(22) Filed: Jun. 25, 2021

(51) Int. Cl. A63H 3/16; A63H 3/00; B42D 15/00

(52) U.S. Cl. CPC A63H 3/16; A63H 3/003; B42D 15/00

(57) ABSTRACT

An assemblable story and picture display may include a plurality of substrates combinable to resemble an object. The assemblable story and picture display may define an outer profile that may resemble an apple, banana, duck, egg, Christmas tree, or any other relatively simple object. Each of the plurality of substrates may define a portion of the outer profile making up the assemblable story and picture display. Each of the plurality of substrates may include a portion of a story or images wherein the story is conveyed sequentially across the plurality of substrates. The assemblable story and picture display may further include an outer decorative image or layer. The assembled story and picture display may include exterior decorative elements indicating the nature of the story depicted on each of the story or display layers.

### TECHNICAL FIELD

The field to which the disclosure generally relates includes 3-dimensional picture and story display, and in particular, a 3-dimensional display comprising a plurality of sequential pieces displaying portions of pictures or stories.

### BACKGROUND

A story and picture display may provide for a plurality of assemblable or stackable pieces which may, when assembled, define a particular assembly profile similar to a known object. Each of the stackable pieces may include sequential picture or story elements contributing to a larger picture or story as a whole.

### SUMMARY OF ILLUSTRATIVE VARIATIONS

An assemblable story and picture display may include a plurality of substrates combinable to resemble an object, such as, and apple. Each of the individual substrates may include story or display layers disposed thereon. Each of the story or display layers may include display or story designs which, when viewed or read in sequence, may convey a story or information. The assembled story and picture display may include exterior decorative elements indicating the nature of the story depicted on each of the story or display layers.

The assemblable story and picture display may include at least one means for assembling the various substrates and layers, such as, a through rod, magnets, or surface features in a lock-and-key or complimentary configuration such that a user may assemble the story and picture display correctly to resemble the object which the assemble story and picture display is modeled after.

The assemblable story and picture display may be constructed and arranged to display pictures or a story sequentially from a first substrate having story or pictures displayed thereon to an nth substrate having story or pictures displayed thereon. As an example, a parable may be shown or displayed across multiple substrates where a user may disassemble the story and picture display to reveal the parable across each subsequent substrate.

Other illustrative variations within the scope of the invention will become apparent from the detailed description provided herein. The detailed description and enumerated variations, while disclosing optional variations, are intended for purposes of illustration only and are not intended to limit the scope of the invention.

### BRIEF DESCRIPTION OF THE DRAWINGS

Examples of variations within the scope of the invention will become more fully understood from the detailed description and the accompanying drawings, wherein:

FIG. 1 depicts one variation of an assemblable story and picture display as described herein;

FIG. 2 depicts a partially exploded view of one variation of an assemblable story and picture display as described herein;

FIG. 3 depicts a disassembled view of the management of an assemblable story and picture display as described herein;

FIGS. 4a and 4b depict side views of an assemblable story and picture display as described herein;

FIG. 5 depicts a variation of an assemblable story and picture display as described herein; and

FIG. 6 depicts a variation of an assemblable story and picture display as described herein.

### DETAILED DESCRIPTION OF ILLUSTRATIVE VARIATIONS

The following description of the variations is merely illustrative in nature and is in no way intended to limit the scope of the invention, its application, or uses. The following description of variants is only illustrative of components, elements, acts, products, and methods considered to be within the scope of the invention and are not in any way intended to limit such scope by what is specifically disclosed or not expressly set forth. The components, elements, acts, products, and methods as described herein may be combined and rearranged other than as expressly described herein and still are within the scope of the invention.

An assemblable story and picture display may include a plurality of substrates combinable to resemble an object such as an apple. The assemblable story and picture display may define an outer profile that may resemble an apple, banana, duck, egg, Christmas tree, or any other relatively simple object. Each of the plurality of substrates may define a portion of the outer profile making up the assemblable story and picture display. The assemblable story and picture display may further include an outer decorative image or layer displaying, as non-limiting examples, a face, text, a design, a color, or the like. The assembled story and picture display may include exterior decorative elements indicating the nature of the story depicted on each of the story or display layers. The assemblable story and picture display may be made up of any suitable material such as, but not limited to, wood, metal, plastic, or the like.

Each of the individual substrates may include a first face opposite a second face. A story or display layer may be disposed on each of the first face and second face. Each of the story or display layers may include display or story designs and which may, when viewed or read in sequence, may depict a sequential story or information. The story or display layers may be printed directly on the first face or second face or may include a prefabricated or pre-printed display layer which may be adhered to the first face or second face. Each display layer may include images or text relevant to a story or puzzle being depicted on the display layers. Display layers may indicate sequential numbers similar to pages of a book such that the assembly order of the individual substrates is more easily understood.

The assemblable story and picture display may include at least one means for assembling the various substrates and layers, such as, a through rod, magnets, or surface features in a lock-and-key or complimentary configuration such that a user may assemble the story and picture display correctly to resemble the object which the assemblable story and picture display is modeled after. As a non-limiting example, the last substrate in the assemblable story and picture display may include a rod extending approximately perpendicular therefrom. Each of the individual substrates may define respective through holes constructed and arranged to allow the rod to pass therethrough, allowing the assemblable story and picture display to be assembled and secured by the rod. As a non-limiting example, each of the individual substrates may include at least one magnet disposed therein such that stacked individual substrates may be attached to one another via magnetic force. The means by which the individual substrates are assembled may include various other methods not explicitly described in this disclosure but which are considered part of the invention.

The assemblable story and picture display may be constructed and arranged to display pictures or a story sequentially from a first substrate having story or pictures displayed thereon to an nth substrate having story or pictures displayed thereon. As an example, a parable may be shown or displayed across multiple substrates where a user may disassemble the story and picture display to reveal the parable across each subsequent substrate.

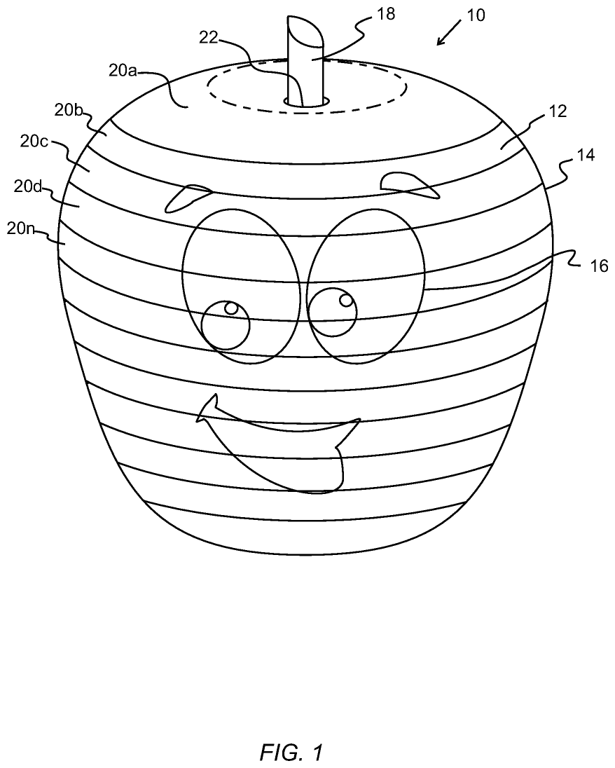

Referring to FIG. 1, an assemblable story and picture display 10 may include a body 12 including a plurality of individual substrates 20a, 20b, 20c, 20d, and 20n wherein 20n indicates nth individual substrates. The body 12 and nth individual substrates may define an outer profile 14 of the assemblable story and picture display 10. As a non-limiting example, FIG. 1 depicts an assemblable story and picture display 10 roughly approximating the appearance of an apple. The outer profile 14 may resemble an object such as, but not limited to, an apple, duck, banana, pair, cherry, train, baseball, head, hand, or the like. Explicitly disclosed outer profiles in this disclosure should not be considered limiting with respect to the outer profile 14. The assemblable story and picture display 10 may include an outer image 16 printed or disposed on the nth substrates such that, when assembled, the outer image 16 is visible on the body 12. Individual substrate 20a may define at least one through hole 22 constructed and arranged to allow a rod 18 to pass therethrough. Each of the nth individual substrates may define respective through holes also constructed and arranged to allow the rod 18 to pass therethrough.

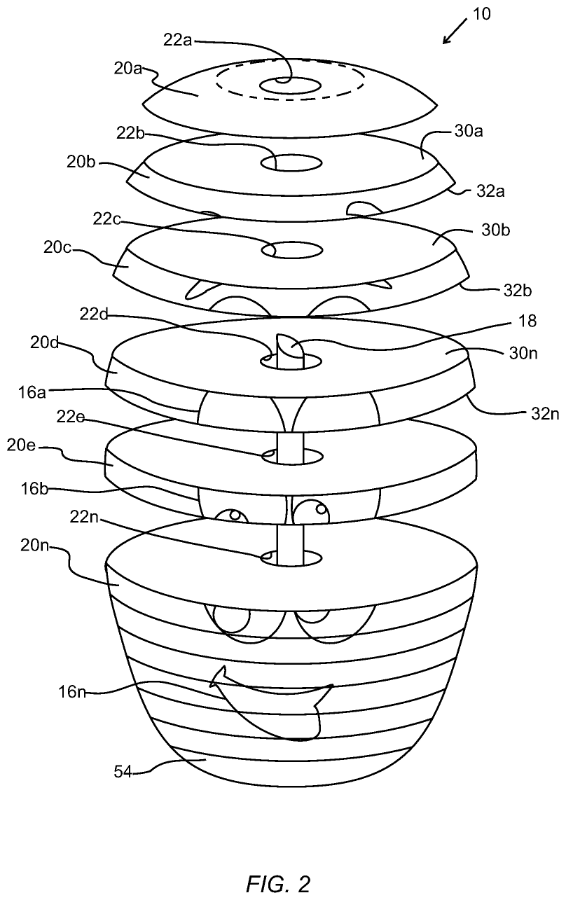

FIG. 2 depicts a partially exploded view of an assemblable story and picture display 10 including a first substrate 20a defining a first through hole 22a. The assemblable story and picture display 10 may include a second substrate 20b defining a second through hole 22b and having a first face 30a opposite a second face 32b. The assemblable story and picture display 10 they include a third substrate 20d defining a third through whole 22d and including a first face 30c opposite a second face 32d. The assemblable story and picture display 10 may include a fourth substrate 20d defining a fourth through hole 22d including a first face 30n opposite a second face 32n. The assemblable story and picture display 10 may include a fifth substrate 20e defining a fifth through hole 22e. The assemblable story and picture display 10 may include numerous other substrates 20n defining through holes 22n therein. Portions of the outer image 16a, 16b, and 16n may be printed on or disposed on each of the individual substrates 20a through 20n. A final substrate 54 may be secured to a rod 18 passing through each of the nth through holes 22n.

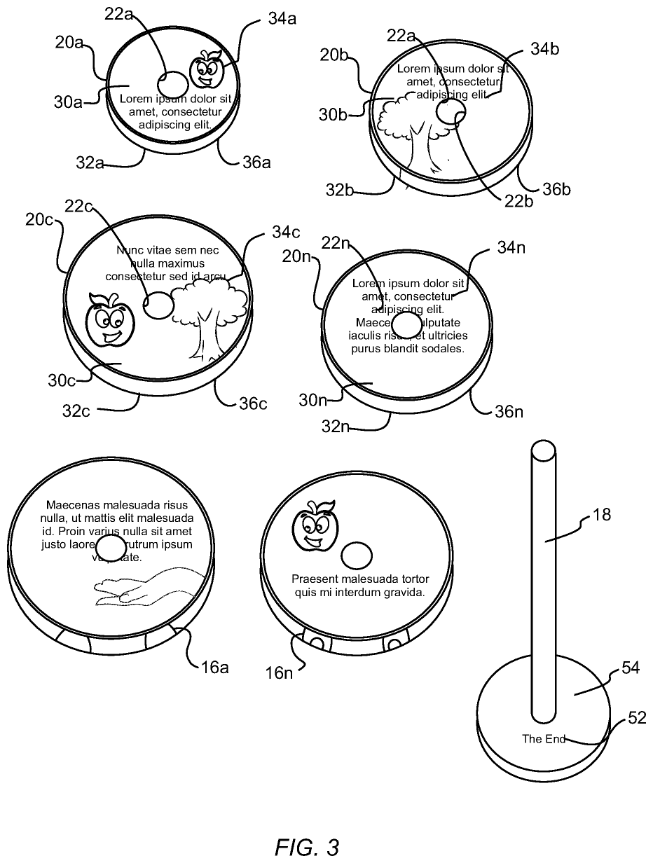

FIG. 3 depicts portions of a disassembled story and picture display including multiple individual substrates 20a, 20b, 20c, and 20n defining respective through holes 22a, 22b, 22c, and 22n. Layers 30a, 30b, 30c, and 30n may be disposed on respective first faces of the individual substrates 20a, 20b, 20c, and 20n and may include respective text or images 34a, 34b, 34c, and 34n. Layers 32a, 32b, 32c, and 32n may be disposed on respective second faces of the individual substrates 20a, 20b, 20c, and 20n and may include respective text or images 36a, 36b, 36c, and 36n. Text or images 34a, 34b, 34c, and 34n and 36a, 36b, 36c, and 36n may be sequential such that a story may be shown or displayed. For example, a first portion of story may be depicted on 34a, a second portion on 36a, a third portion on 34b, a fourth portion on 36b, a fifth portion on 34c, a sixth portion on 36c, and so on. Portions of the outer image 16a though 16n may be printed on or disposed on each of the individual substrates 20a through 20n. A final image 52 may be printed or disposed on the final substrate 54 indicating the end of the images or stories depicted by the story and picture display.

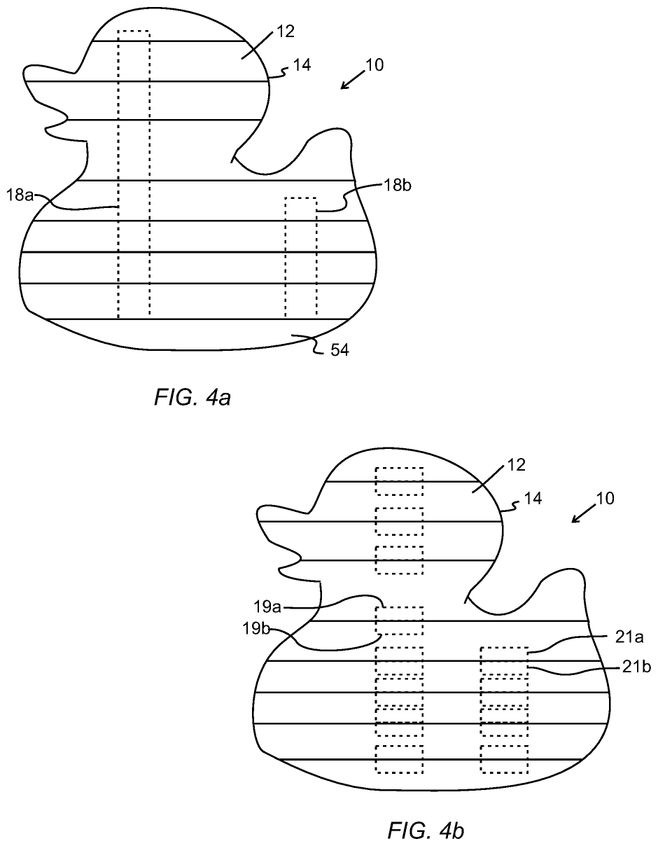

FIG. 4a depicts a cross sectional view of a story and picture display 10 including a body 12 made up of substrates and defining an outer profile 14. The final substrate 54 may be secured to rods 18a and 18b to allow secure assembly of the story and picture display 10. each of the substrates may define complementary through holes to receive rods 18a an 18b. While two rods are shown, it should be understood than any number of rods may be implemented in securing the assembly of the story and picture display.

FIG. 4b depicts a cross sectional view of a story and picture display 10 including a body 12 made up of substrates and defining an outer profile 14. A first pair of complementary magnets 19a and 19b may be disposed within a portion of each of the individual substrates and may be constructed and arranged to facilitate the assembly of the story and picture display 10 such that each substrate may be magnetically connected to at least one other individual substrate. Multiple pairs of complementary magnets 21a and 21b may further facilitate assembly of the story and picture display 10.

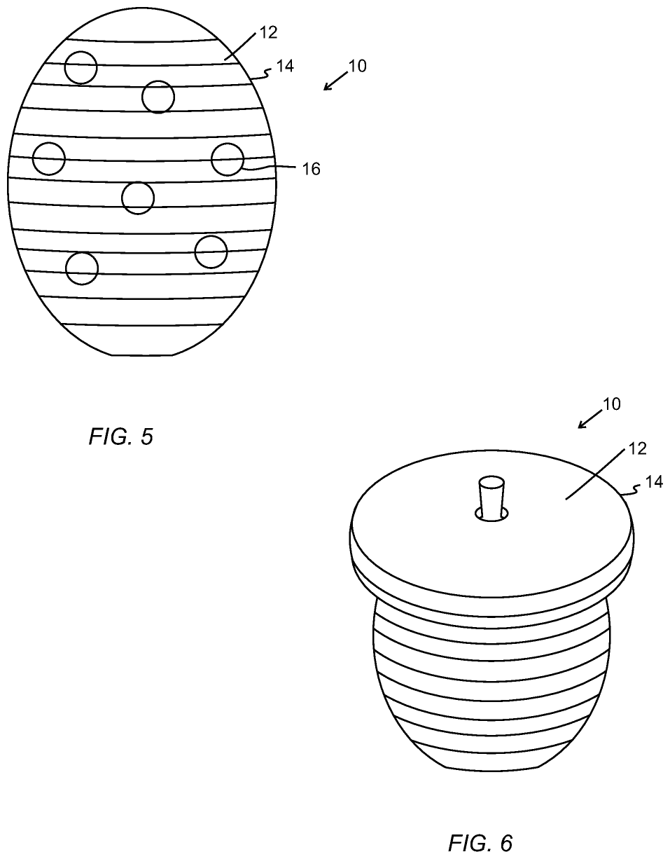

FIGS. 5 and 6 depicts illustrative variations of a story and picture display 10 including a body 12 made of a plurality of substrates and defining an outer profile 14. For example, the outer profile 14 may resemble an egg, acorn, ball, pyramid, animal, or any other object. Outer image 16 may further facilitate the resemblance of the story and picture display 10 to a familiar object.

The present invention includes the description, examples, variations, and drawings disclosed; but it is not limited to such description, examples, variations, or drawings. As briefly described above, the reader should assume that features of one disclosed variation can also be applied to all other disclosed variations, unless expressly indicated to the contrary. Unless expressly indicated to the contrary, the numerical parameters set forth in the present application are approximations that can vary depending on the desired properties sought to be obtained by a person of ordinary skill in the art without undue experimentation using the teachings disclosed in the present application. Modifications and other variations will be apparent to a person of ordinary skill in the packaging arts, and all such modifications and other variations are intended and deemed to be within the scope of the present invention.

What is claimed is:

1. An assemblable story and picture display comprising:
a body comprising a plurality of individual substrates defining an outer profile;
each individual substrate having a first face opposite a second face, at least one through hole defined by the individual substrate, and an outer edge, each outer edge contributing to defining the outer profile;
a plurality of decorative images disposed on the first face and the second face of each individual substrate; and
a rod secured approximately perpendicular to a last individual substrate, the rod being constructed and arranged to receive each of the individual substrates by passing the rod through each of the at least one through holes.

2. An assemblable story and picture display as in claim 1, wherein the plurality of decorative images are sequential and are constructed and arranged to convey a story.

3. An assemblable story and picture display as in claim 1, wherein the plurality of decorative images are adhered directly to the first face and second face.

4. An assemblable story and picture display as in claim 1, further comprising:
a plurality of decorative layers disposed on each first face and second face, the plurality of decorative images being disposed on the plurality of decorative layers.

5. An assemblable story and picture display as in claim 4, wherein the plurality of decorative layers are secured to the first face and second face by an adhesive.

6. An assemblable story and picture display as in claim 1, further comprising an outer decorative image on the body and plurality of individual substrates.

7. An assemblable story and picture display as in claim 1, wherein the outer profile resembles a fruit.

8. An assemblable story and picture display as in claim 1, wherein the outer profile resembles an animal.

9. An assemblable story and picture display as in claim 1, wherein the outer profile resembles a plant.

10. An assemblable story and picture display comprising:
a body comprising a plurality of individual substrates defining an outer profile of the body;
each individual substrate having a first face opposite a second face and an outer edge, each outer edge contributing to defining the outer profile;
a plurality of decorative layers disposed on the first face and the second face of each individual substrate, wherein each of the plurality of decorative layers comprises a decorative image thereon; and
a plurality of individual magnets, each of the plurality of individual magnets disposed within the plurality of individual substrates such that the plurality of individual substrates may be secured to one another via magnetic force.

11. An assemblable story and picture display as in claim 1, wherein the plurality of decorative images are sequential and are constructed and arranged to convey a story.

12. An assemblable story and picture display as in claim 1, wherein the plurality of decorative images are adhered directly to the first face and second face.

13. An assemblable story and picture display as in claim 1, further comprising:
a plurality of decorative layers disposed on each first face and second face, the plurality of decorative images being disposed on the plurality of decorative layers.

14. An assemblable story and picture display as in claim 4, wherein the plurality of decorative layers are secured to the first face and second face by an adhesive.

15. An assemblable story and picture display as in claim 1, further comprising an outer decorative image on the body and plurality of individual substrates.

16. An assemblable story and picture display as in claim 1, wherein the outer profile resembles a fruit.

17. An assemblable story and picture display as in claim 1, wherein the outer profile resembles an animal.

18. An assemblable story and picture display as in claim 1, wherein the outer profile resembles a plant.

19. An assemblable story and picture display comprising:
a body comprising a plurality of individual substrates defining an outer profile;
each individual substrate having a first face opposite a second face, at least one through hole defined by the individual substrate, and an outer edge, each outer edge contributing to defining the outer profile;
an outer decorative image on the body and plurality of individual substrates;
a plurality of decorative layers disposed on each first face and second face;
a plurality of decorative images disposed on the plurality of decorative layers of each individual substrate wherein the plurality of decorative images are sequential and are constructed and arranged to convey a story; and
at least one rod secured approximately perpendicular to a last individual substrate, the at least one rod being constructed and arranged to receive each of the individual substrates by passing the at least one rod through each of the at least one through holes.

20. An assemblable story and picture display as in claim 4, wherein the plurality of decorative layers are secured to the first face and second face by an adhesive.
